(19) United States
(12) Patent Application Publication
(10) Pub. No.: US 2008/0288865 A1
(43) Pub. Date: Nov. 20, 2008

(54) APPLICATION WITH IN-CONTEXT VIDEO ASSISTANCE

(75) Inventors: Daniel Joseph Raffel, San Francisco, CA (US); Jonathan James Trevor, Santa Clara, CA (US); Pasha Sadri, Menlo Park, CA (US); Edward Ho, San Jose, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/749,683

(22) Filed: May 16, 2007

(51) Int. Cl. G06F 3/00

(52) U.S. Cl. 715/709

(57) ABSTRACT

At least one computing device provides user assistance functionality associated with an application. The application is executed, including causing at least one user interface to be displayed via which a user may interact with the application. Each user interface corresponds to a particular function. For each function, in a portion of the user interface corresponding to that function, a user interface element is caused to be provided that, when activated, causes a user assistance video to be played regarding that function. Executing applications are thus provided associated in-context user assistance video tutorials. The users of the application are provided a mechanism to access the user assistance video tutorials in the context of the interface for which the help is sought.

### BACKGROUND

Applications, whether provided locally, remotely, or a combination of both, are many times not intuitive for users to operate. As a result, many applications provide user assistance functionality. One type of user assistance functionality is accessible via a help menu, which is typically not contextually tied to the functions for which help is requested. Thus, for example, a user desiring assistance with a function may need to first access a help menu and then type, in a search field of a help function, a keyword relating to the function after accessing the help menu, which would then result in textual and/or graphic material being displayed that may then be of assistance in using the function.

Other types of user assistance are more contextually tied to the function for which help is desired. For example, one type of user assistance includes providing a text balloon with information about a particular feature whenever the cursor is rolled a portion of the display for that feature.

### SUMMARY

In accordance with an aspect, at least one computing device provides user assistance functionality associated with an application. The application is executed, including causing at least one user interface to be displayed via which a user may interact with the application. Each user interface corresponds to a particular function. For each function, in a portion of the user interface corresponding to that function, a user interface element is caused to be provided that, when activated, causes a user assistance video to be played regarding that function.

Executing applications are thus provided associated in-context user assistance video tutorials. The users of the application are provided a mechanism to access the user assistance video tutorials in the context of the interface for which the help is sought.

### BRIEF DESCRIPTION OF THE DRAWINGS

FIG. 1 is a block diagram illustrating a simplistic example of a display in which a plurality of user interfaces are displayed, including a user interface element that, when activated, causes a user assistance video to be played regarding a function to which the user interface corresponds.

FIG. 2 illustrates an example of the FIG. 1 display, showing a user assistance video for a function with which a user interface corresponds being displayed in a portion of the display.

FIG. 3 is a flowchart illustrating an example of processing to accomplish the displays of FIG. 1 and FIG. 2.

FIG. 4, FIG. 5 and FIG. 6 illustrate an example of the FIG. 3 method, wherein the application is a pipe specification editor system to configure a pipe for processing a syndication data feed.

Specifically, FIG. 4 illustrates an example user interface element, in the form of a video help button, being displayed in conjunction with the display of a module to process a syndication data feed originating from Flickr. FIG. 5 illustrates an example display that is similar to the display in FIG. 4, but in which the video help button has been activated. FIG. 6 illustrates an example in which a video help button for a particular user interface is displayed based on an indication being received of a particular user action with respect to that particular user interface.

FIG. 7 is a simplified diagram of a network environment in which specific embodiments of the present invention may be implemented.

### DETAILED DESCRIPTION

The inventors have realized that it would be desirable to provide executing applications with associated in-context user assistance video tutorials. More particularly, the inventors have realized it would be desirable to provide a mechanism for users of the application to access the user assistance video tutorials in the context of the interface for which the help is sought.

In accordance with an aspect, an application is operated (executed by at least one computing device), including causing at least one user interface to be displayed. A user may interact with the application via the at least one user interface to selectively cause a plurality of functions to be performed. For example, the user interface may be caused to be displayed via a browser. For each of the plurality of functions, in a portion of one of the at least one user interface corresponding to that function, a user interface element is provided that, when activated, causes a user assistance video to be played regarding that function.

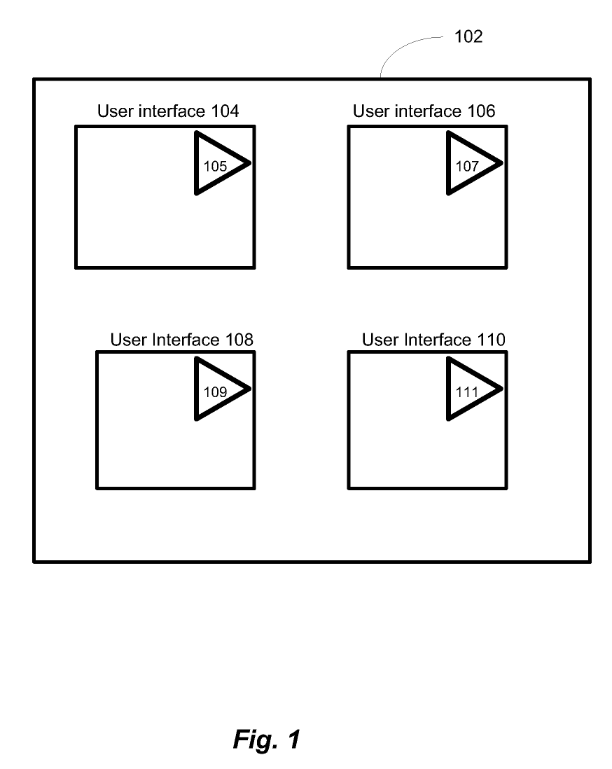

FIG. 1 is a block diagram illustrating a simplistic example of an application display 102, in which a plurality of such user interfaces are displayed. More particularly, referring to FIG. 1, the display 102 comprises four user interfaces 104, 106, 108 and 110. Each of the user interfaces includes a user interface element 105, 107, 109 and 111, respectively that, when activated, causes a user assistance video to be played regarding a function to which the user interface of the user interface element corresponds.

In some examples, the user interface element corresponds to a function of the application such that, when the user interface element is activated, the application executes to cause the function to be performed. In other examples, the user interface element corresponds to a portion of a design, where the application is for determining the design that, when instantiated, will be such that the portion of the design to which the user interface corresponds will perform the function.

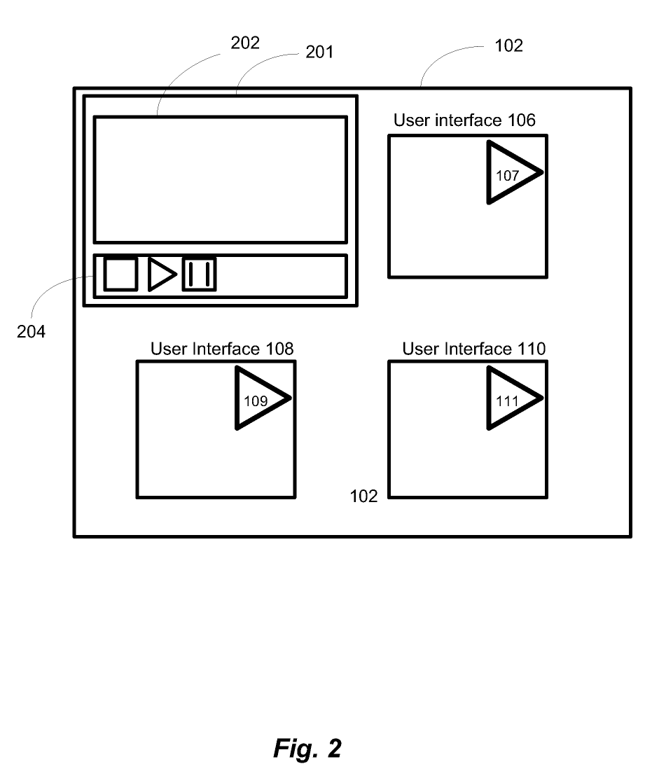

For example, FIG. 2 illustrates an example of the display 102 that shows a user assistance video for a function to which the user interface 106 corresponds being presented in a portion 201 of the display 102. More particularly, the user assistance video is being presented based on activation of the user interface element 107 included as part of the user interface 106. In the FIG. 2 example, the display portion 201 in which the user assistance video is being presented includes a video display portion 202 and a user video control portion 204. The user video control portion 204 includes, for example, standard “stop,” “play” and “pause” buttons for a user to control the manner of presentation of the user assistance video. Later, we discuss a specific example of a user assistance video.

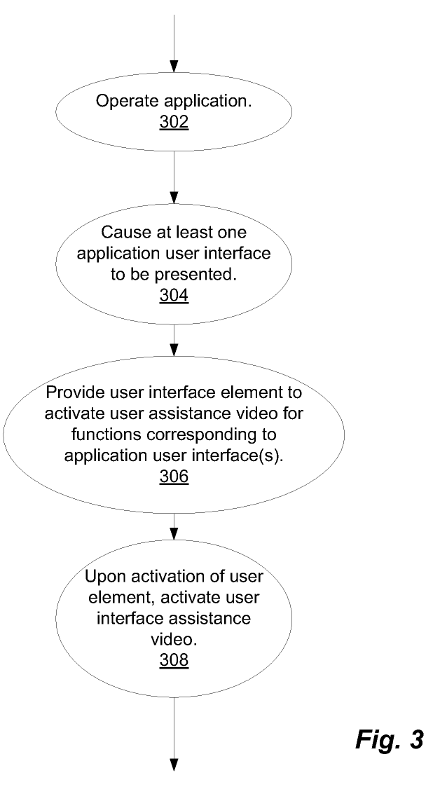

FIG. 3 is a flowchart illustrating an example of processing to accomplish the displays of FIG. 1 and FIG. 2. Unless otherwise specifically noted, the order of steps in the FIG. 3 flowchart is not intended to imply that the steps must be carried out in a specific order. Turning now to FIG. 3, at step 302, an application is operated. The application may be, for example, executed locally, remotely (e.g., via a network), or a combination of both. At step 304, at least one application user interface is caused to be presented (for example, the user interfaces 104, 106, 108 and 110 in FIG. 1). At step 306, user interface elements (for example, user interface elements 105, 107, 109 and 111 in FIG. 1) are provided, corresponding to the displayed application user interfaces. At step 308, upon activation of a user interface element, a user assistance video (such as in the video display portion 202 in FIG. 2) is caused to be provided. An example of activation includes a result of a user clicking on the user interface element, though the user interface element may be activated in other ways, as well, in the examples.

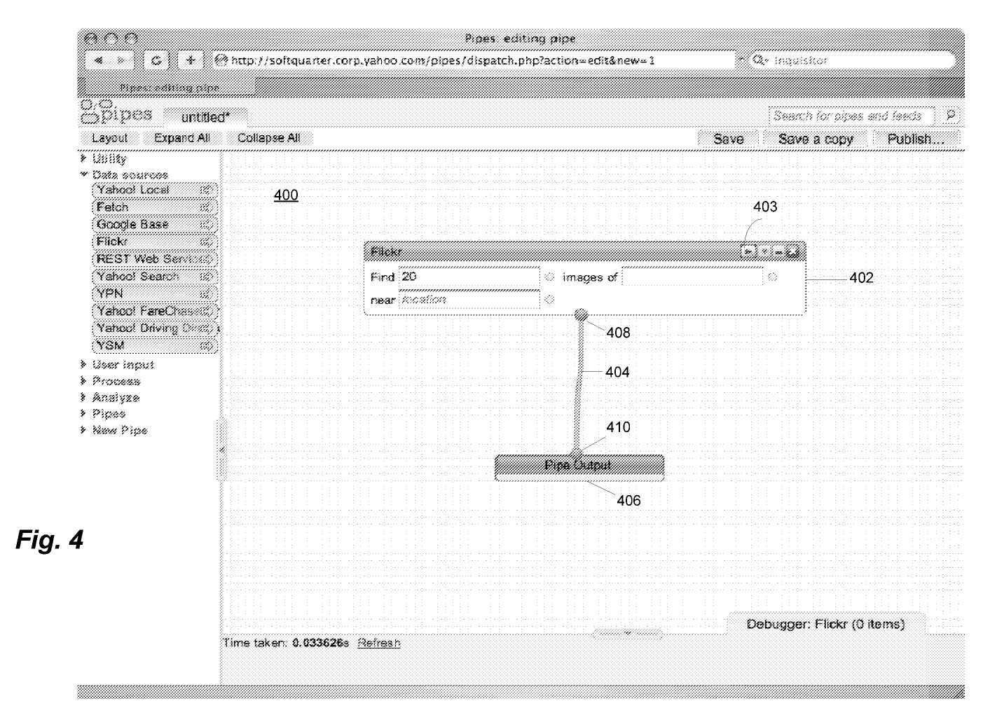

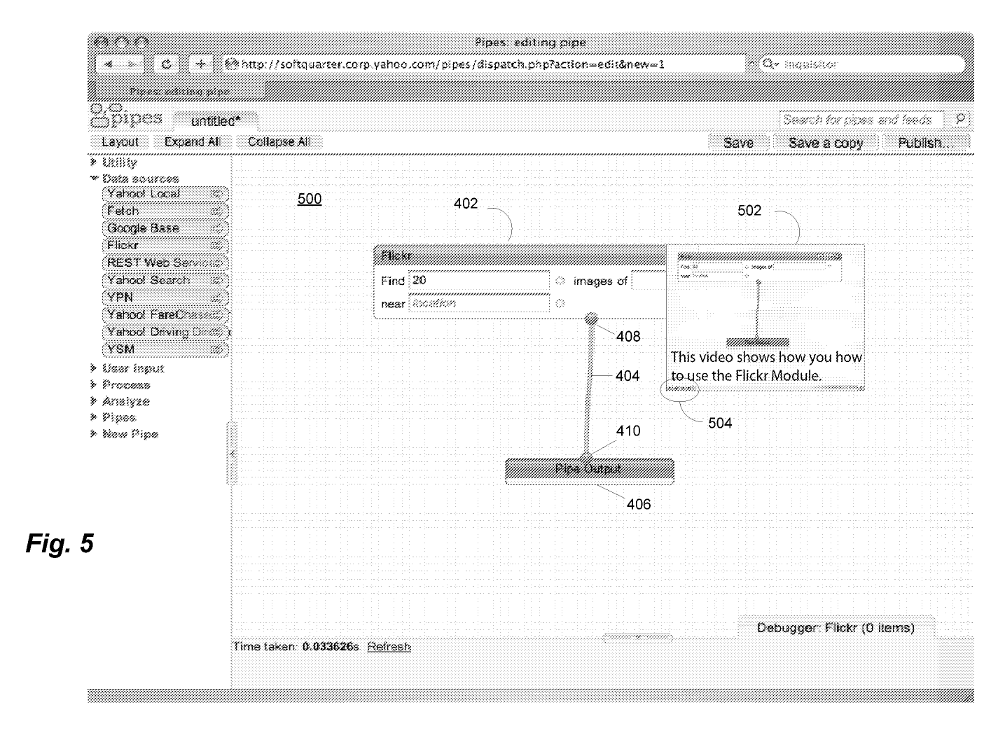

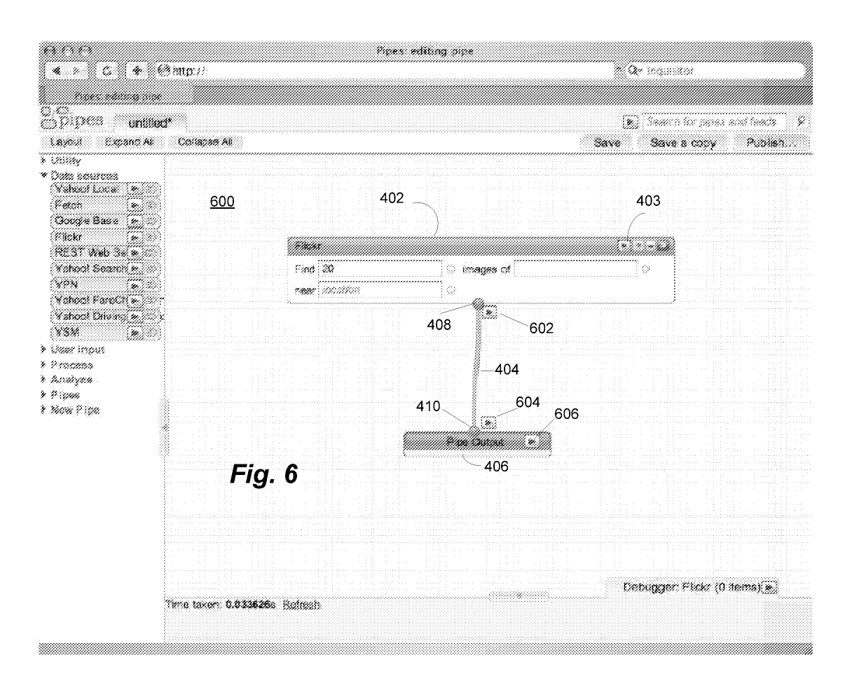

FIG. 4, FIG. 5 and FIG. 6 illustrate specific example displays resulting from steps of the FIG. 3 method, for an application that is a pipe specification editor system to configure a pipe for processing a syndication data feed. An example of such a pipe specification editor system is disclosed in co-pending patent application Ser. No. 11/613,960 (the '960 application, having Attorney Docket Number YAH1P039), filed Dec. 20, 2006 and which is incorporated herein by reference in its entirety. More particularly, the pipe specification editor system provides a graphical user interface to receive a user-specified configuration of a plurality of constituent pipes, a pre-specified configuration or a combination of both. Each constituent pipe is characterized by one or more pipes and/or modules, and each constituent pipe is further characterized by at least one of a group consisting of an input node and an output node. The specified configuration may specify a wire to connect an output node of one constituent module to an input node of another constituent module.

Turning now specifically to the FIG. 4 display output of a pipe specification editor, a display 400 includes a display of two modules 402, 406 connected by a wire 404. In the example, the module 402 is a module to process a syndication data feed originating from Flickr, which is an online photo-sharing service provided by Yahoo! Inc., of Sunnyvale, Calif. The module 402 may be user-configured as disclosed, for example, in the '960 application. A user interface element, in the form of a video help button 403, is displayed in conjunction with the display of the module 402. In the FIG. 4 illustration, the video help button 403 has not been activated, and a corresponding user assistance video is not being displayed. Also in the FIG. 4 display 400, a wire 404 is displayed indicating an output 408 of the module 402 is connected to an input 410 of a pipe output module 406.

In some examples, the video that is presented is predefined, based on a particular context in which the help is requested. This may mean, for example, that a particular video is always associated with a particular user interface that results from executing the application or with a particular user interface element associated with a particular user interface. For example, for a particular one of the modules in the FIG. 4 display output of a pipe specification editor, there may always be a particular video associated with that module.

In other examples, the context based on which the video help is presented is configurable. For example, a user interface for which video help is available may be configurable or the context in which the user interface is provided may be configurable (e.g., how that user interface is connected to other user interfaces and/or to what other user interfaces that user interface is connected). Examples of these are provided in the '960 application, referenced above. In these examples, the video that is presented may be predefined based on the configured context. For example, a module displayed by the pipe specification editor may have a user-choosable field with three choices, and there may be a different predefined video help provided depending on which of the three choices the user made for the field. For example, a “rename” module may provide the user a choice of copying a value or providing the value. The video help that is provided for the “rename” module may depend on the context of the user's choice of renaming method. As another example, where a module displayed by the pipe specification editor may be connected to various other modules, a different predefined video help may be provided depending on to which various other modules the module is connected. For example, part of a module arrangement may include an output of a fetch feed module being provided to a filter module, whereas part of another module arrangement may include an output of a fetch feed module being provided directly to a pipe output module.

In some examples, the video that is presented may not be predefined but, rather, definitions may be “built” depending on the configuration of the context in which the video help is presented. For example, the definitions may be high level “action” scripts (in the theatrical sense) or animation instructions suitable for languages like “Flash.” The result may be a two-dimensional animation that illustrates how something can be accomplished. Again using the pipe specification editor example, video segments corresponding to actions such as “dragging a module on,” connecting a line,” and “setting a value” may all be combined to shows a contextual help video for the particular context configuration (which may be considered to comprise, for example, a plurality of sub-contexts, with each video segment corresponding to a particular one of the sub-contexts). This may include, for example, even causing the video to include a replica of the present state of the pipe specification editor display with, for example, the particular modules the user has already caused to be displayed as well as configurations of those modules and connections between those modules.

In some examples as well, a plurality of videos may be provided (e.g., played, presented and/or offered), where the videos and the orders in which they are provided may depend on the context from which the videos are requested.

FIG. 5 illustrates a result of activating the video help button 403 (FIG. 4). More specifically, FIG. 5 illustrates a display 500 that is similar to the display 400, but in which the video help button 403 (FIG. 4) has been activated. The display 500 includes a video display portion 502 in which a user assistance video is provided regarding functionality of the Flickr constituent module 402. Within the video display portion 502, a video control user interface 504 may also be provided.

In some examples, the user interface element for activating a user assistance video for a function is always displayed (e.g., by default or by configuration) in conjunction with display of a user interface for that function. For example, in the FIG. 4 example, the video help button 403 is always displayed in correspondence with display of the Flickr module 402 including, for example, how the user may configured the Flickr constituent module 402. On the other hand, FIG. 6 illustrates an example in which a video help button for a particular user interface is displayed based on an indication being received of a particular user action with respect to that particular user interface. In the FIG. 6 example, the particular user action includes the user causing a cursor to “hover” over the particular user interface.

As illustrated in FIG. 6, the user causing a cursor to hover over the output 408 of the Flickr module 402 causes the video help button 602 to be displayed in conjunction with the display of the output 408. The user causing a cursor to hover over the input 410 of the pipe output module 406 causes the video help button 604 to be displayed in conjunction with the display of the pipe output module 406. As also illustrated in FIG. 6, the user causing a cursor to hover over the pipe output module 406 causes the video help button 606 to be displayed in conjunction with the display of the pipe output module 406. Based on an indication that the user has activated one of the video help buttons 604, 606 and 608, an appropriate user assistance video is caused to be displayed.

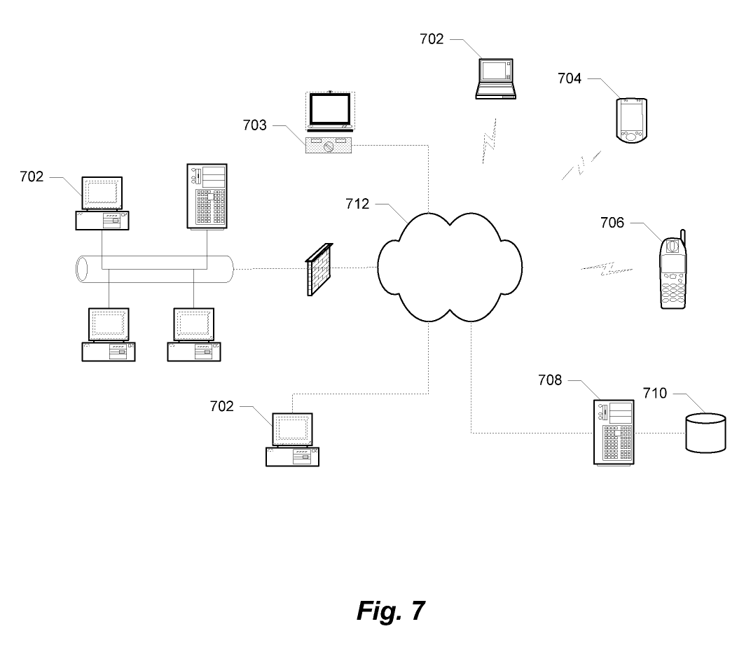

Embodiments of the present invention may be employed to facilitate evaluation of binary classification systems in any of a wide variety of computing contexts. For example, as illustrated in FIG. 7, implementations are contemplated in which users may interact with a diverse network environment via any type of computer (e.g., desktop, laptop, tablet, etc.) 702, media computing platforms 703 (e.g., cable and satellite set top boxes and digital video recorders), handheld computing devices (e.g., PDAs) 704, cell phones 706, or any other type of computing or communication platform.

According to various embodiments, applications may be executed locally, remotely or a combination of both. The remote aspect is illustrated in FIG. 7 by server 708 and data store 710 which, as will be understood, may correspond to multiple distributed devices and data stores.

The various aspects of the invention may also be practiced in a wide variety of network environments (represented by network 712) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

We have described a mechanism to provide executing applications with associated in-context user assistance video tutorials. More particularly, we have described a mechanism for users of the application to access the user assistance video tutorials in the context of the interface for which the help is sought.

1. A method, implemented by at least one computing device, of providing user assistance functionality associated with an application, the method comprising:
executing the application, including causing at least one user interface to be displayed via which a user may interact with the application, each user interface corresponding to a particular function; and
for each function, in a portion of the user interface corresponding to that function, causing a user interface element to be provided that, when activated, causes a user assistance video to be played regarding that function.

2. The method of claim 1, wherein:
the at least one user interface is caused to be displayed via a browser interacting with the application.

3. The method of claim 1, wherein:
the user interface element corresponds to a portion of a design, where the application is for determining the design that, when instantiated, will be such that the portion of the design to which the user interface corresponds will perform the function

4. The method of claim 1, wherein:
the application is an application to specify a system having a plurality of modules; and
the plurality of user interface elements correspond to the modules or to connections between the modules.

5. The method of claim 4, wherein:
the system having a plurality of modules is a system of a plurality of constituent pipes, each constituent pipe characterized by one or more pipes and/or modules, each constituent pipe characterized by at least one of a group consisting of an input node and an output node, wherein
the input node, if present, is configured to input a syndication data feed and the output node, if present, is configured to output a syndication data feed; and
at least one of the constituent pipes includes a module configured to retrieve a source syndication data feed;
wherein each constituent pipe is further characterized by an input node and an output node, wherein the input node and output node of a constituent pipe correspond to input nodes and output nodes of pipes and/or modules by which that pipe is characterized
each of the plurality of user interface elements that, when activated, cause a user assistance video to be played regarding the function corresponding to that user interface element corresponds to a module or to a connection between modules.

6. The method of claim 1, wherein:
the step of providing the user interface element that, when activated, causes a user assistance video to be played regarding that function, includes processing an indication that a user has activated the user interface to which the user interface element corresponds.

7. The method of claim 1, wherein:
the user assistance video includes video demonstrating actions that may be taken by the user with respect to the user interface for which the user assistance video is displayed.

8. The method of claim 1, further comprising:
processing an indication that a particular one of the user interface elements is activated; and
causing the user assistance video to be played without a navigation away from a display in which the user interface is displayed.

9. The method of claim 8, wherein:
the user assistance video is caused to be played in a popup window of a display associated with the application.

10. The method of claim 1, wherein:
the user assistance video is predetermined based at least in part on a context of the function regarding which the user assistance video is caused to be played.

11. The method of claim 1, wherein:
the user assistance video is dynamically determined based at least in part on a configuration of a configurable context of the function regarding which the user assistance video is caused to be played.

12. The method of claim 11, wherein:
dynamically determining the user assistance video includes generating an action script corresponding to the configuration of the configurable context of the function.

13. The method of claim 1, wherein:
the context of the function includes a plurality of sub-contexts and the user assistance video is dynamically determined based at least in part on the plurality of sub-contexts.

14. The method of claim 1, wherein:
the context of the function includes a plurality of sub-contexts and the user assistance video includes a plurality of segments, and
each segment is dynamically determined based at least in part on a corresponding sub-context.

15. A computing system including at least one computing device, configured to provide user assistance functionality associated with an application, the at least one computing device configured to:
execute the application, including causing at least one user interface to be displayed via which a user may interact with the application, each user interface corresponding to a particular function; and
for each function, in a portion of the user interface corresponding to that function, cause a user interface element to be provided that, when activated, causes a user assistance video to be played regarding that function.

16. The computing system of claim 15, wherein:
the at least one computing device is configured to cause the at least one user interface to be displayed via a browser interacting with the application.

17. The computing system of claim 15, wherein:
the user interface element corresponds to a portion of a design, where the application is for determining the design that, when instantiated, will be such that the portion of the design to which the user interface corresponds will perform the function

18-24. (canceled)

25. A computer program product for providing user assistance functionality associated with an application, the computer program product comprising at least one computer-readable medium having computer program instructions stored therein which are operable to cause at least one computing device to:
execute the application, including causing at least one user interface to be displayed via which a user may interact with the application, each user interface corresponding to a particular function; and
for each function, in a portion of the user interface corresponding to that function, cause a user interface element to be provided that, when activated, causes a user assistance video to be played regarding that function.

26. The computer program product of claim 25, wherein:
the user assistance video is predetermined based at least in part on a context of the function regarding which the user assistance video is caused to be played.

27. The computer program product of claim 25, wherein:
the computer program instructions are operable to cause the at least one computing device to be configured such that the user assistance video is dynamically determined based at least in part on a configuration of a configurable context of the function regarding which the user assistance video is caused to be played.

28. The computer program product of claim 27, wherein:
the computer program instructions being operable to cause the at least computing device to be configured to dynamically determine the user assistance video includes the computer program instructions being operable to cause the at least one computing device being configured to generate an action script corresponding to the configuration of the configurable context of the function.

29. The computer program product of claim 27, wherein:
the context of the function includes a plurality of sub-contexts and the computer program instructions are operable to cause the at least one computing device is configured to dynamically determine the user assistance video based at least in part on the plurality of sub-contexts.

30. The computer program product of claim 27, wherein:
the context of the function includes a plurality of sub-contexts and the user assistance video includes a plurality of segments, and
the computer program instructions are operable to cause the at least one computing device is configured to dynamically determine each segment based at least in part on a corresponding sub-context.

31. A method, implemented by at least one computing device, of providing user assistance functionality associated with an application, the method comprising:
executing the application, including causing at least one user interface to be displayed via which a user may interact with the application, each user interface corresponding to a particular function; and
for each function, in a portion of the user interface corresponding to that function, causing a user interface element to be provided that, when activated, causes at least one user assistance videos to be provided regarding that function.

32. The method of claim 31, wherein:
the at least one user assistance video is a plurality of user assistance videos, and the plurality of user assistance videos are provided in a manner that is based at least in part on a context of the function from which the user interface element is activated.
